(19) United States
(12) Patent Application Publication
(10) Pub. No.: US 2006/0159359 A1
(43) Pub. Date: Jul. 20, 2006

(54) Fine granularity scalable video encoding and decoding method and apparatus capable of controlling deblocking

(75) Inventor: Bae-keun Lee, Bucheon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/333,206

(22) Filed: Jan. 18, 2006

Related U.S. Application Data
(60) Provisional application No. 60/644,582, filed on Jan. 19, 2005.

(30) Foreign Application Priority Data
Feb. 7, 2005 (KR) 10-2005-0011423

(51) Int. Cl. G06K 9/46

(52) U.S. Cl. 382/240

(57) ABSTRACT

Disclosed herein is a Fine Granularity Scalability (FGS)-based video encoding and decoding method and apparatus capable of controlling deblocking. In the video decoding method according to the present invention, original video data is received and a base layer is generated based on the original data. Next, the difference between the original data and data that is obtained by reconstructing the base layer and deblocking the reconstructed base layer is obtained, thus generating an enhancement layer. Then, a reconstructed frame is generated based on the data that is obtained by reconstructing the enhancement layer, and data that is obtained by reconstructing and deblocking the reconstructed base layer. Finally, the reconstructed frame is deblocked at a lower intensity than that of deblocking performed in the first two steps.

### CROSS-REFERENCE TO RELATED APPLICATIONS

This application claims priority from Korean Patent Application No. 10-2005-0011423 filed on Feb. 7, 2005 in the Korean Intellectual Property Office, and U.S. Provisional Patent Application No. 60/644,582 filed on Jan. 19, 2005 in the United States Patent and Trademark Office, the disclosures of which are incorporated herein by reference in their entirety.

### BACKGROUND OF THE INVENTION

1. Field of the Invention

The present invention relates to a fine granularity scalable video encoding and decoding method and apparatus capable of controlling deblocking.

2. Description of the Related Art

Since multimedia data is large, a high capacity storage medium and a wide bandwidth is required to store and transmit the multimedia data, respectively. Therefore, in order to transmit multimedia data including text, moving pictures (hereinafter referred to as “video”), and audio, a compression and coding technique must be used. Of methods of compressing multimedia data, in particular, video compression methods can be classified into lossy/non-lossy compression, intra-frame/inter-frame compression, and symmetric/asymmetric compression according to whether original data is lost, whether data is independently compressed for each frame, and whether the time required for compression is the same as the time for reconstruction, respectively. Compression when the resolution of frames varies is classified as scalable compression.

The purpose of conventional video coding is to transmit information optimized for a given bit rate. However, in network video applications, such as streaming video over the Internet, the performance of a network is not constant, but changes according to the circumstances. Accordingly, flexible coding is required, in addition to the purpose of conventional video encoding which is to perform optimal coding for a predetermined bit rate.

Scalability is a technique using a base layer and an enhancement layer, and allowing a decoder to observe the processing status, network status, and others, and to perform selective decoding with respect to time, space, or the Signal-to-Noise Ratio (SNR). Of scalabilities, Fine Granularity Scalability (FGS) encodes the base layer and the enhancement layer. After the enhancement layer has been encoded, the encoded enhancement layer may not be transmitted or decoded according to the transmission efficiency of a network or the status of a decoder. Through FGS, data can be suitably transmitted according to a bit rate.

Meanwhile, video encoding is performed to code and transmit a plurality of blocks in a single screen. Accordingly, at the time of decoding video, visible boundaries between blocks may appear. The operation of smoothing the boundaries between blocks is called deblocking, and a component for smoothing the boundaries is called a deblocking filter.

If the intensity of deblocking filtering is increased, the strength of smoothing boundaries is increased, so that the boundaries between blocks may disappear. However, information may disappear due to the deblocking filter, so that the selection of a deblocking filter greatly influences performance.

Therefore, an apparatus and method for efficiently using a deblocking filter and supporting FGS are required.

### SUMMARY OF THE INVENTION

Accordingly, the present invention has been made keeping in mind the above problems occurring in the prior art, and an aspect of the present invention is to provide an encoding and decoding method and apparatus, which can perform low-intensity deblocking in video encoding and decoding that supports FGS, thus improving a Peak Signal to Noise Ratio (PSNR).

Another aspect of the present invention is to provide an encoding and decoding method and apparatus, which improve video quality while reducing data loss caused by deblocking.

The object of the present invention is not limited to the above aspects, and other aspects, not described, will be clearly understood by those skilled in the art from the following descriptions.

In accordance with one aspect of the present invention to accomplish the above objects, there is provided a FGS-based video encoding method capable of controlling deblocking, comprising the steps of (a) receiving original data of video and generating a base layer based on the original data, (b) obtaining a difference between data that are obtained by reconstructing the base layer and deblocking the reconstructed base layer, and the original data, thus generating an enhancement layer, (c) generating a reconstructed frame, based on the data that are obtained by reconstructing the enhancement layer, and data that are obtained by reconstructing and deblocking the reconstructed base layer, and (d) deblocking the reconstructed frame at a lower intensity than that of deblocking that has been performed in step (b) or (c).

In accordance with another aspect of the present invention, there is provided a FGS-based video decoding method capable of controlling deblocking, comprising the steps of (a) receiving a video stream and extracting a base layer from the video stream, (b) extracting an enhancement layer from the video stream, (c) adding data that are obtained by reconstructing and deblocking the base layer, to data that are obtained by reconstructing the enhancement layer, thus generating a reconstructed frame, and (d) deblocking the reconstructed frame at a lower intensity than that of deblocking performed in step (c).

In accordance with a further aspect of the present invention, there is provided a FGS-based video encoder capable of controlling deblocking, comprising a base layer generation unit for generating a base layer based on original data of video, an enhancement layer generation unit for obtaining a difference between data that are obtained by reconstructing and deblocking the base layer, and the original data, thus generating an enhancement layer, a reconstructed frame generation unit for generating a reconstructed frame, based on data that are obtained by reconstructing the enhancement layer, and data that are obtained by reconstructing and deblocking the base layer, and a first deblocking unit for deblocking the reconstructed frame at a lower intensity than that of deblocking performed by the enhancement layer generation unit or the reconstructed frame generation unit.

In accordance with yet another aspect of the present invention, there is provided a FGS-based video decoder capable of controlling deblocking, comprising a base layer extraction unit for extracting a base layer from a received video stream, an enhancement layer extraction unit for extracting an enhancement layer from the received video stream, a reconstructed frame generation unit for adding data that are obtained by reconstructing and deblocking the base layer, to data that are obtained by reconstructing the enhancement layer, thus generating a reconstructed frame, and a first deblocking unit for deblocking the reconstructed frame at a lower intensity than that of deblocking performed by the reconstructed frame generation unit.

### BRIEF DESCRIPTION OF THE DRAWINGS

FIG. 1 is a diagram showing an apparatus for encoding video that supports FGS according to an embodiment of the present invention;

FIG. 2 is a diagram showing an apparatus for decoding video that supports FGS according to an embodiment of the present invention;

FIG. 3 is a diagram showing an apparatus for encoding video that supports FGS according to another embodiment of the present invention;

FIG. 4 is a diagram showing an apparatus for decoding video that supports FGS according to another embodiment of the present invention;

FIG. 5 is a flowchart showing a process of encoding the original data of a video according to an embodiment of the present invention;

FIG. 6 is a flowchart showing a process of decoding a received video stream according to an embodiment of the present invention;

FIG. 7 is a view showing an example of reconstruction results for a base layer and enhancement layers according to an embodiment of the present invention;

FIGS. 8A and 8B are graphs showing the degree of improvement of a PSNR according to an embodiment of the present invention; and

FIGS. 9A and 9B are graphs showing the degree of improvement of a PSNR according to another embodiment of the present invention.

### DESCRIPTION OF THE PREFERRED EMBODIMENTS

Hereinafter, exemplary embodiments of the present invention will be described in detail with reference to the attached drawings. The features and advantages of the present invention will be more clearly understood from the exemplary embodiments, which will be described in detail in conjunction with the accompanying drawings. However, the present invention is not limited to the exemplary embodiments, which will be disclosed later, but can be implemented in various forms. The exemplary embodiments are provided to complete the disclosure of the present invention, and to sufficiently disclose the scope of the present invention to those skilled in the art. The present invention should be defined by the attached claims. The same reference numerals are used throughout the different drawings to designate the same or similar components.

The terms “unit” and “module”, which are used in the exemplary embodiments of the present invention, denote software components, or hardware components, such as a Field-Programmable Gate Array (FPGA) or an Application Specific Integrated Circuit (ASIC). Each module executes certain functions. A module can be implemented to reside in an addressable storage medium, or to run on one or more processors. Therefore, as an example, a module includes various components, such as software components, object-oriented software components, class components and task components, processes, functions, attributes, procedures, sub-routines, segments of program code, drivers, firmware, microcode, circuits, data, databases, data structures, tables, arrays and variables. The functions provided by the components and modules can be combined into a small number of components and modules, or can be separated into additional components or modules. Moreover, components and modules can be implemented to drive one or more central processing units (CPUs) in a device or security multimedia card.

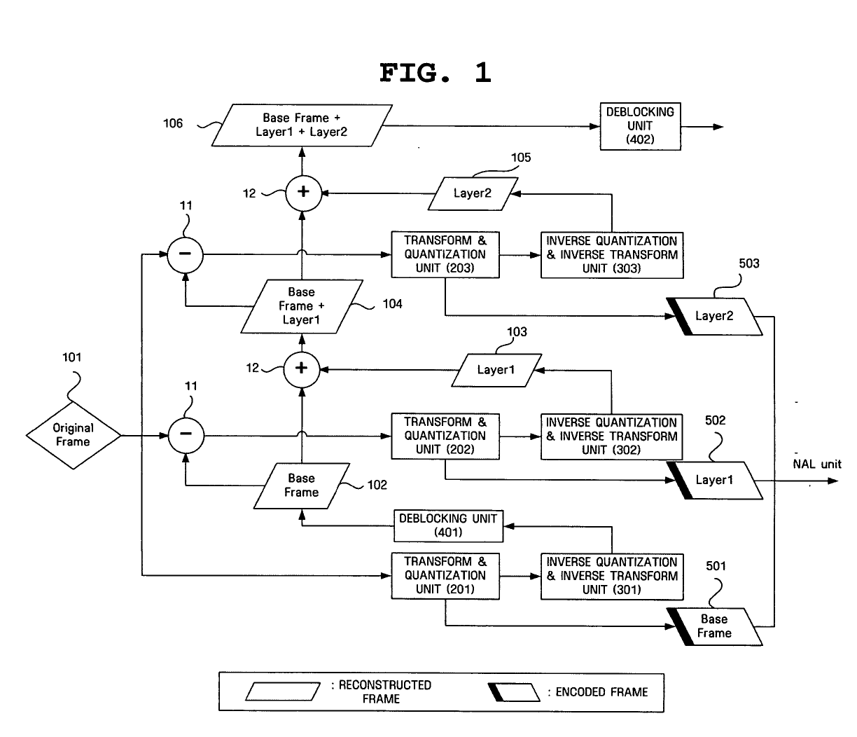

FIG. 1 is a diagram showing an apparatus for encoding video that supports FGS according to an exemplary embodiment of the present invention. First, a base layer is generated using an original frame 101. The original frame 101 may be a frame extracted from a group of pictures (GOP), and it may be obtained by performing Motion-Compensated Temporal Filtering (MCTF) on the GOP. In order to extract a base layer from the original frame, a transform & quantization unit 201 performs transformation and quantization. As a result, a base layer frame 501 is generated.

Since an enhancement layer denotes data to be added to the base layer, the difference between the original frame and the base layer frame is obtained. Residual data obtained by the difference is used later in such a way that a decoder obtains original video data by adding corresponding residual data to the original frame. The data obtained by the decoder is inversely quantized and inversely transformed with respect to the original frame. Accordingly, the base layer frame, calculated by the transform & quantization unit 201, is inversely quantized and inversely transformed by an inverse quantization & inverse-transform unit 301 in order to reconstruct the base layer frame.

Further, the decoder performs deblocking to eliminate boundaries between blocks constituting the reconstructed frame; deblocking is performed on the frame reconstructed by a deblocking unit 401.

The difference between the reconstructed base layer frame 102 calculated by the inverse quantization & inverse transform unit 301 and the original frame 101 is obtained by a subtracter 11. Data obtained using the subtracter 11 is transformed and quantized by a transform & quantization unit 202 in order to generate a first enhancement layer frame 502. The first enhancement layer frame is added to the reconstructed base layer frame 102 in order to generate a second enhancement layer frame. For this operation, the first enhancement layer frame is reconstructed using an inverse quantization & inverse transform unit 302 so that a first reconstructed enhancement layer frame 103 is generated. The frames 103 and 102 are added to each other by an adder 12 to generate a new frame 104. The difference between the frame 104 and the original frame 101 is obtained by a subtracter 11. Residual data, obtained by the difference, is transformed and quantized by a transform & quantization unit 203 to generate a second enhancement layer frame 503. The above process is repeated so that a third enhancement layer frame, a fourth enhancement layer frame, and others can be successively generated.

The base layer frame 501, the first enhancement layer frame 502 and the second enhancement layer frame 503 generated in this way can be transmitted in the form of a Network Abstraction Layer unit (NAL unit). When the frames are transmitted as a NAL unit, the decoder can reconstruct data even if part of the received NAL unit is truncated.

Further, deblocking is performed on a reconstructed frame 106 that is obtained by adding the second reconstructed enhancement layer frame 105, reconstructed by an inverse quantization & inverse transform unit 303, to the frame 104 through the adder 12. In this case, since the base layer frame has already been deblocked by the deblocking unit 401, a deblocking coefficient decreases when deblocking is performed by a deblocking unit 402. Generally, a high deblocking coefficient is assigned when deblocking is performed by the deblocking unit 402, but an over-smoothing problem occurs. In the exemplary embodiment of the present invention, the deblocking coefficient is set to a low value, such as 1 or 2, for the deblocking unit 402 so as to prevent the above problem, thus decreasing the degree of deblocking and preventing over-smoothing. The reconstructed frame, deblocked in this way, can be referred to when other frames are generated.

As an example of video data in FIG. 1, a temporal sub-band picture is generated by performing MCTF on a GOP constituting video, and original data is extracted from the temporal sub-band picture. The original data is down-sampled from all of the data. If this data is transformed through a Discrete Cosine Transform (DCT) or a wavelet transform, and quantized and encoded, the base layer is generated.

The transform & quantization units 201, 202 and 203 of FIG. 1 can perform lossy encoding. Part of the original information is lost because it is transformed through a DCT and quantized. Accordingly, this encoding is called lossy encoding.

The transform & quantization unit 201 of FIG. 1 is an exemplary embodiment of a base layer generation unit for generating a base layer, and the transform & quantization units 202 and 203 for generating enhancement layers are exemplary embodiments of an enhancement layer generation unit. The reconstructed frames are indicated by reference numerals 102, 104, 106, 103 and 105, and the inverse quantization & inverse transform units 301, 302 and 303 for generating the reconstructed frames are exemplary embodiments of a reconstructed frame generation unit.

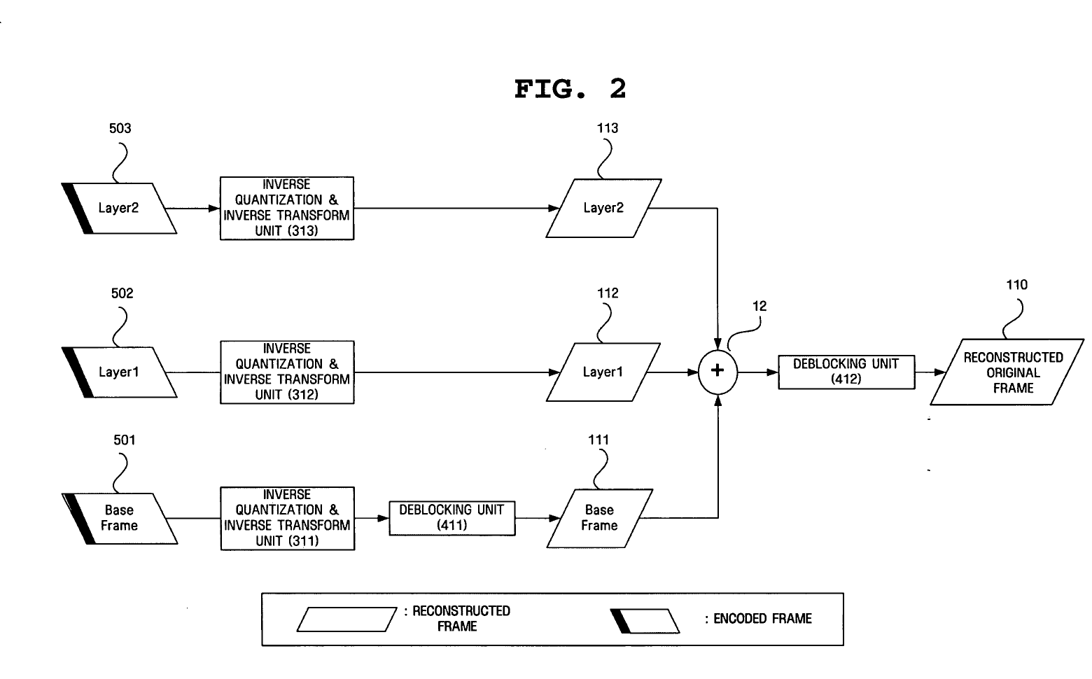

FIG. 2 is a diagram of an apparatus for decoding video to support FGS according to an exemplary embodiment of the present invention. The base layer frame 501, the first enhancement layer frame 502 and the second enhancement layer frame 503, generated in the process shown in FIG. 1, are received, and since these frames are encoded data, they are decoded by inverse quantization & inverse transform units 311, 312 and 313. At this time, a reconstructed base layer frame 111 is obtained through a deblocking block 411.

Frames 111, 112 and 113, which have been decoded and reconstructed, are added to each other by an adder 12. Deblocking is performed on the added frames by a deblocking unit to eliminate the boundaries between blocks. In this case, the base layer frame has already been deblocked by the deblocking unit 411 so that a coefficient for deblocking, which is performed by the deblocking unit 412, decreases to 1 or 2 in the embodiment of the present invention. After deblocking has been completed in this way, a reconstructed original frame is reproduced.

The inverse quantization & inverse transform unit 311 of FIG. 2 is an exemplary embodiment of a base layer extraction unit for extracting a base layer, and the inverse quantization & inverse transform units 312 and 313 for extracting enhancement layers are exemplary embodiments of an enhancement layer extraction unit. Reconstructed frames are indicated by reference numerals 111, 112 and 113, and the adder 12 for adding the frames to each other is an embodiment of a reconstructed frame generation unit.

FGS, depicted in FIGS. 1 and 2, uses an enhancement layer of a Scalable Video Model (SVM) 3.0. A NAL unit obtained as a result of FGS can be truncated at a specific point, and frames can be reconstructed using data existing up to the truncation point. In this case, data to be transmitted corresponds to a base layer, and other enhancement layers can be flexibly transmitted depending on the transmission status of a network. All enhancement layers have residual data occurring due to the difference between the enhancement layers and the base layer (or a reconstructed frame composed of the base layer and a previous enhancement layer). A quantization parameter QPi is a parameter for generating an i-th enhancement layer. As the magnitude of the quantization parameter increases, the step size increases. Therefore, at the time of generating enhancement layers, data can be obtained while the magnitude of the quantization parameter gradually decreases.

If video is encoded through lossy encoding, the combination of lost data and the number of bits required for encoding is the cost. For example, if it is assumed that lost data is E, the required bits are B, a predetermined coefficient is λ, then the cost of encoding C is:
C=E+λB

Therefore, criteria for determining the number of enhancement layers to be generated can be calculated based on the cost. In FIGS. 1 and 2, enhancement layers including two stages are generated.

The exemplary embodiments of the present invention shown in FIGS. 1 and 2 perform deblocking at a low intensity when enhancement layers are directly encoded, or when enhancement layers are added to a base layer and decoded, thus reducing information loss caused by excessive deblocking.

FGS, described with reference to FIGS. 1 and 2, is applied to the SVM 3.0. An exemplary embodiment for implementing FGS using another method is described below.

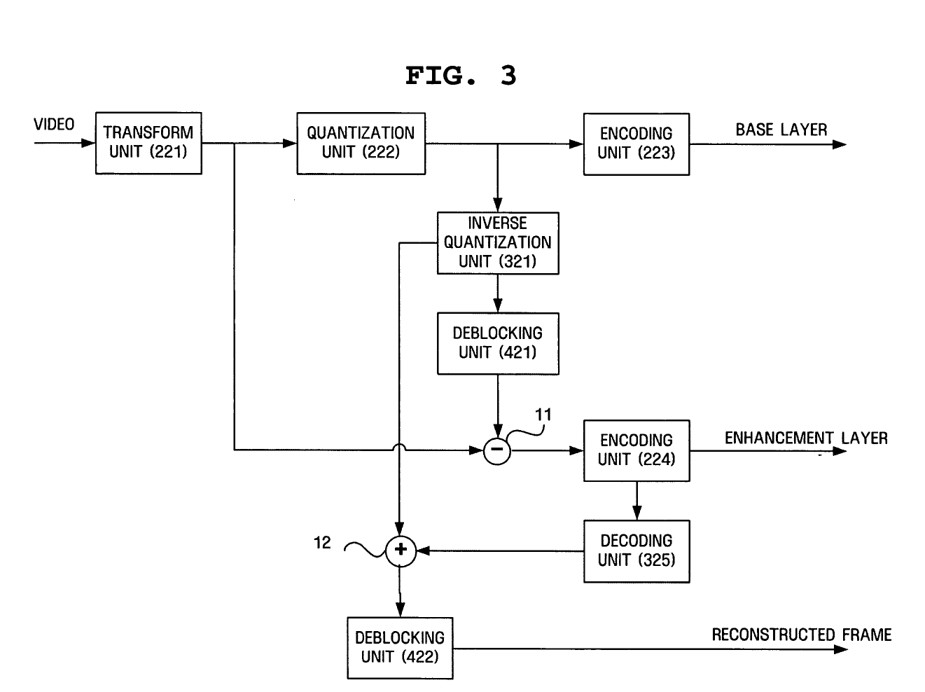

FIG. 3 is a diagram of an apparatus for encoding video to support FGS according to another embodiment of the present invention. Unlike FIG. 1, a base layer and an enhancement layer are generated, and the enhancement layer is implemented through a bit plane.

In FIG. 3, original video data is transformed by a transform unit 221. As an example of transform, a Discrete Cosine Transform (DCT) can be used. A base layer is generated if data obtained as the result of the DCT transform is quantized by a quantization unit 222, and the quantized data is encoded by an encoding unit 223 that uses entropy encoding or variable length coding (VLC). Meanwhile, since the difference between the base layer and the original video data is obtained to generate an enhancement layer, the data that has been quantized by the quantization unit 222 is inversely quantized by an inverse quantization unit 321. In this case, since deblocking is performed in a decoder, deblocking is also performed by a deblocking unit 421 in an encoding stage, and then residual data, the difference between deblocked data and the original video data, is obtained. Then, the residual data is encoded again by an encoding unit 224. As in the case of a bit plane, of respective bits, the Most Significant Bit (MSB), the next MSB, . . . , the Least Significant Bit (LSB) can be grouped in the form of a bit plane, and then encoded. The enhancement layer generated by the encoding unit 224 is transmitted with the base layer.

Meanwhile, in order to obtain reference information required to generate another frame, a reconstructed frame that can be obtained using the base layer and the enhancement layer is necessary. In this case, deblocking is performed by a deblocking unit 422 in order to reconstruct the frame. In this case, since the deblocking is performed by the deblocking unit 422 after the deblocking for the base layer has been performed by the deblocking unit 421, a deblocking coefficient is decreased, thus preventing the occurrence of over-smoothing.

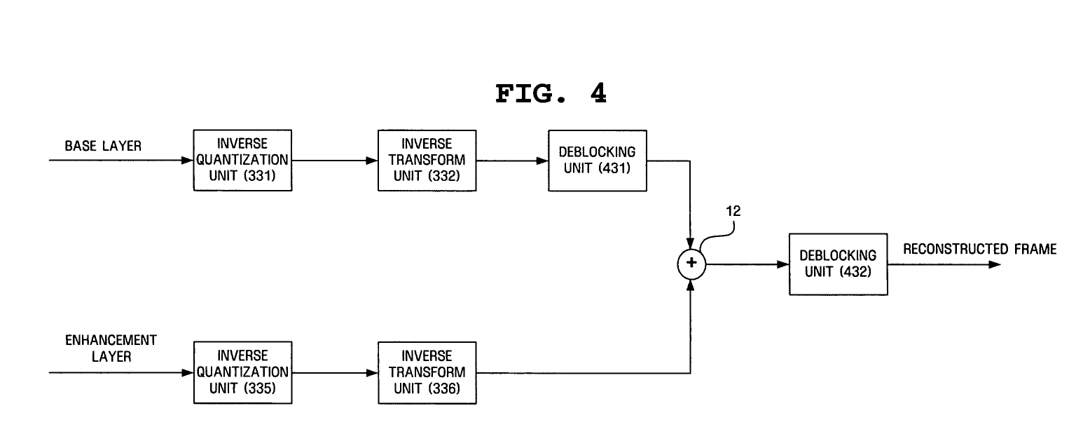

FIG. 4 is a view of an apparatus for decoding video to support FGS according to another exemplary embodiment of the present invention. Unlike FIG. 2, a base layer and an enhancement layer are received. Data of the enhancement layer can be partially truncated in one enhancement layer depending on the receiving capability or decoding capability of a decoding stage (decorder).

Both the base layer and the enhancement layer, transmitted in a stream format, are inverse quantized and inverse transformed. The base layer is reconstructed by a deblocking unit 431 after passing through an inverse quantization unit 331 and an inverse transform unit 332. Further, the enhancement layer is reconstructed through an inverse quantization unit 335 and an inverse transform unit 336. The reconstructed base layer and enhancement layer are added to each other by an adder 12 so that a single reconstructed frame is created. At this time, deblocking is performed by a deblocking unit 432. However, since deblocking has been performed on the base layer by the deblocking unit 431, a deblocking coefficient is decreased at the time of performing deblocking on the reconstructed frame through the deblocking unit 432, thus preventing the occurrence of over-smoothing. If over-smoothing occurs, data in a corresponding portion disappears, causing data loss.

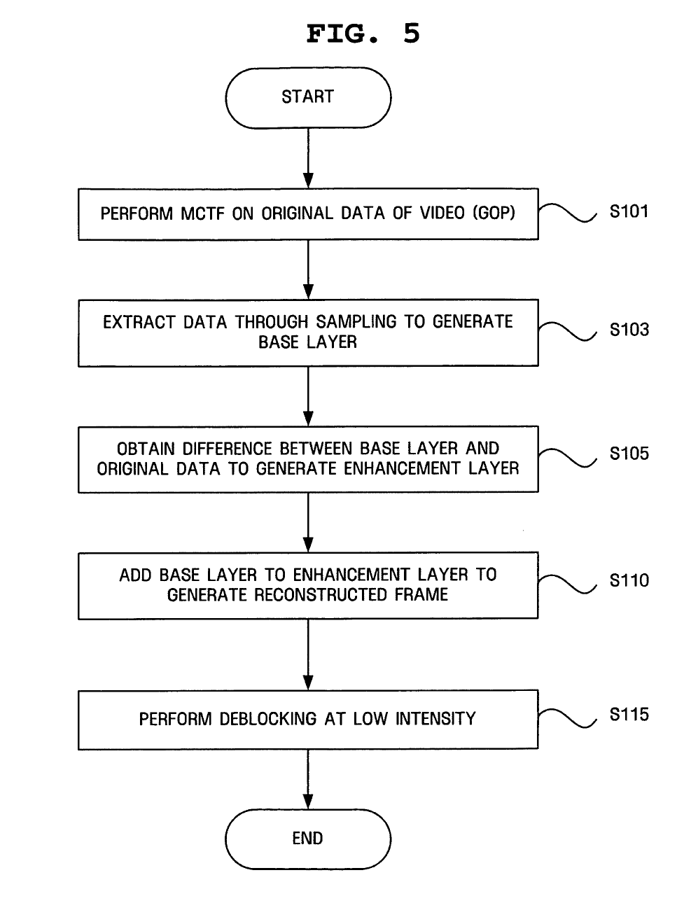

FIG. 5 is a flowchart showing a process of encoding the original data of video according to an embodiment of the present invention.

MCTF is performed on original data constituting video so that a frame is generated in step S101. The original data may be a GOP composed of a plurality of frames. In this process, a motion vector is obtained through motion estimation, and a motion compensated frame is configured using the motion vector and a reference frame. Further, the difference between a current frame and the motion compensated frame is obtained so that a residual frame is obtained, thus reducing temporal redundancy. As the motion estimation method, various methods, such as fixed size block matching or Hierarchical Variable Size Block Matching (HVSBM), can be used. MCTF is one method of providing temporal scalability, and some methods of implementing the MCTF includes a method using a Haar filter, a Motion Adaptive Filtering (MAF) method, a method using a 5/3 filter. The results, calculated by these methods, provide temporally scalable video data. Thereafter, in order to provide SNR scalable video data using this data, a process of generating base layer data and enhancement layer data is executed.

In order to provide SNR scalability in a frame that is generated to be temporally scalable, such as MCTF, data is divided into a base layer and an enhancement layer. The base layer is extracted from a frame, on which the MCTF has been performed, through sampling in step S103. The base layer can be compressed using several schemes. In the case of motion compensation video encoding, a DCT can be used. The base layer becomes the basis for generating the enhancement layer so that various existing video encoding methods can be used. The base layer can be generated by the transform & quantization units 201, 202 and 203 of FIG. 1, or the transform unit 221, the quantization unit 222 and the encoding unit 223 of FIG. 3.

Next, residual data, obtained by the difference between the base layer, generated in step S103, and the original data generated in step S101, is extracted, so the enhancement layer is generated in step S105. In order to generate the enhancement layer, various fine-granular schemes can be used. For example, a wavelet method, a DCT method, and a matching-pursuit based method can be used. It is well known that, of these methods, the bitplane DCT coding method and the embedded zero-tree wavelet (EZW) method exhibit excellent performance.

Meanwhile, in order to obtain residual data in step S105, an inverse quantization procedure to inversely quantize a quantized base layer may be further required. For this operation, the base layer is reconstructed by the inverse quantization & inverse transform units 301, 302 and 303 of FIG. 1, or the inverse quantization unit 321 of FIG. 3, as described above.

In the decorder, video data can be obtained by adding the enhancement layer to the base layer that has been inversely quantized; the base layer must be inverse quantized to obtain the residual data in order to reduce data loss. At this time, deblocking can be performed after inverse quantization has been performed. Deblocking is used to smooth the boundaries between blocks constituting frames. The difference between the base layer, which was inversely quantized, and the original data, on which MCTF was performed in step S101, is obtained, so that the enhancement layer is generated, as described above.

In step S105, one or more enhancement layers may exist. As the number of enhancement layers increases, the unit of FGS is subdivided, thereby improving SNR scalability. The decorder can determine the number of enhancement layers to be received and to be decoded, depending on its decoding capability or reception capability.

If base layer data and enhancement layer data are generated with respect to a single frame, a procedure of adding the base layer data to the enhancement layer data and generating a new reconstructed frame is required in step S110. The reconstructed frame becomes the basis for generating other frames, or is necessary for generating a predictive frame for motion estimation. In this case, since boundaries between blocks exist in the reconstructed frame, deblocking is performed to eliminate the boundaries between blocks. The reconstructed frame includes the base layer, which has been deblocked in step S105, so that deblocking is performed at a low intensity in step S115.

If deblocking is performed with respect to the reconstructed frame using a high deblocking coefficient, data loss may increase, so that a deblocking coefficient decreases to about 1 or 2, and thus, deblocking is performed at a low intensity.

The result of deblocking, performed in FIG. 5, is expressed in the equations that follow.

If it is assumed that base layer data is B, enhancement layer data is E1, E2, . . . , En, and deblocking performed on the base layer data in step S105 is D1, the reconstructed frame F, obtained in step S110, can be expressed as D1(B)+E1 +E2+ . . . +En. Further, the result of the deblocking performed in step S115 is: D2 (D1(B)+E1+E2+ . . . +En). In this case, the deblocking coefficient df2 of D2 may be set to 1 or 2.

The exemplary embodiment of FIG. 5 shows that, after original video data is transformed to provide temporal scalability, the transformed data is divided into base layer data and enhancement layer data to provide SNR scalability. However, this processing sequence is not necessarily performed. After base layer data and enhancement layer data is obtained to provide SNR scalability for original video data regardless of whether corresponding data is used to provide temporal scalability, a new transform procedure for providing another type of scalability may be conducted. Further, for the MCTF procedure, a plurality of schemes may be employed, and the present invention is not limited to these schemes.

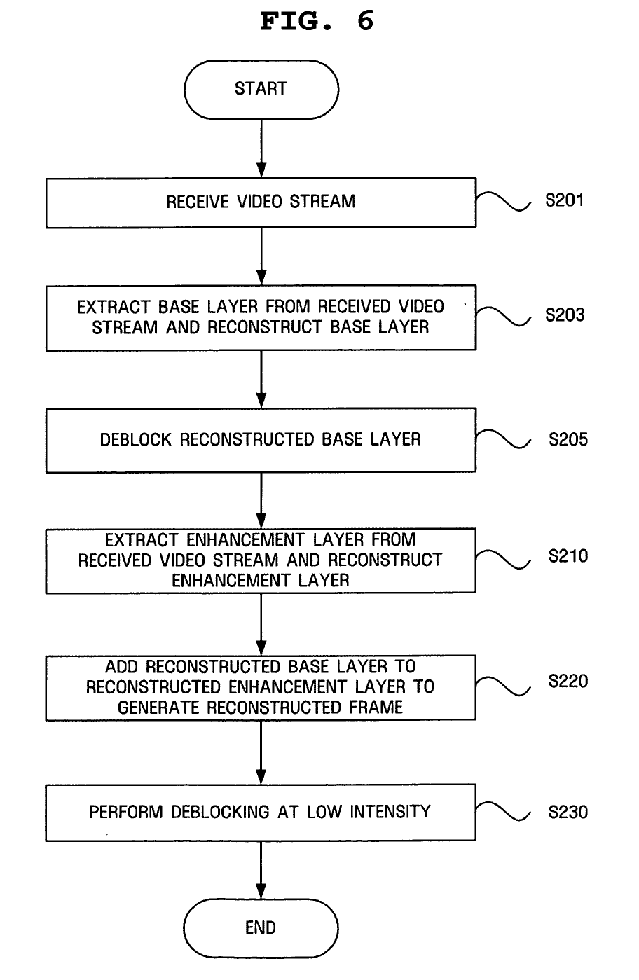

FIG. 6 is a flowchart showing a process of decoding a received video stream according to an exemplary embodiment of the present invention. In detail, a process of a decoder receiving and decoding a video stream is described in the following.

The decoder receives the video stream in step S201. The decoder extracts a base layer from the received video stream, and reconstructs the base layer in step S203. The reconstruction of the base layer is performed through an inverse quantization and an inverse transform. The reconstructed base layer is deblocked in order to be added to other enhancement layers in step S205. Further, an enhancement layer is extracted from the received video stream, and the extracted enhancement layer is reconstructed in step S210. The reconstruction of the enhancement layer is also performed through an inverse quantization and an inverse transform. The base layer, deblocked in step S205, and the enhancement layer, reconstructed in step S210, are added to each other, so that a reconstructed frame is generated in step S220. Further, deblocking is performed on the reconstructed frame with a deblocking coefficient of 1 or 2 in step S230. Since the base layer has already been deblocked once in step S205, deblocking is performed at a low intensity to prevent over-smoothing in step S230.

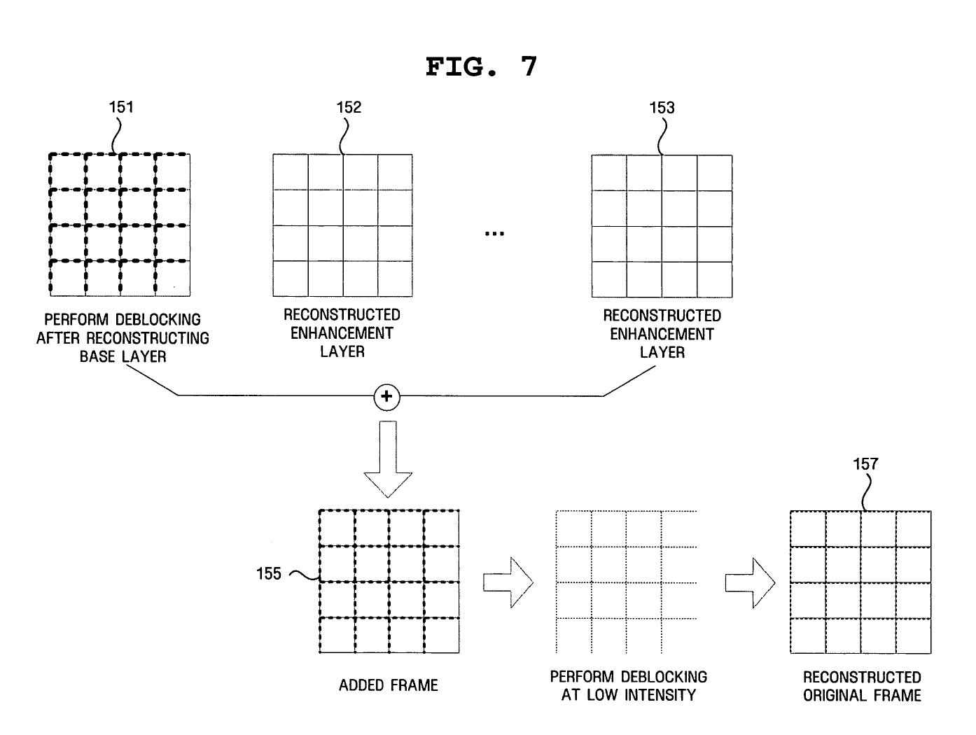

FIG. 7 is a diagram showing an example of reconstruction results for a base layer and enhancement layers according to an embodiment of the present invention. FIG. 7 illustrates the generation of a reconstructed frame, which has been deblocked by the deblocking unit 402 of FIG. 1, or a reconstructed frame, which has been deblocked by the deblocking unit 412 of FIG. 2. Further, FIG. 7 also illustrates the generation of a reconstructed frame, which has been deblocked by the deblocking unit 422 of FIG. 3, or a reconstructed frame, which has been deblocked by the deblocking unit 432 of FIG. 4.

A frame 151 denotes a frame obtained by deblocking a reconstructed base layer after reconstructing the base layer again. That is, the frame 151 is obtained by performing deblocking through the deblocking unit 401 of FIG. 1, the deblocking unit 411 of FIG. 2, the deblocking unit 421 of FIG. 3, or the deblocking unit 431 of FIG. 4. Reference numeral 152 or 153 is a frame obtained by reconstructing an enhancement layer. The reconstruction of the enhancement layer is performed by the inverse quantization & inverse transform units 302 and 303 of FIG. 1, the inverse quantization & inverse transform units 312 and 313 of FIG. 2, the decoding unit 325 of FIG. 3, or the inverse transform unit 336 of FIG. 4. The reconstructed enhancement layers and the reconstructed base layer, which has been deblocked, are added by an adder to produce a single frame 155. In t h i s case, deblocking is performed again. As described above, if a deblocking coefficient is decreased and deblocking is performed, over-smoothing may be prevented. Through this process, the original frame 157 is reconstructed.

In the exemplary embodiment of low-intensity deblocking described in FIGS. 5 and 6 the deblocking coefficient or deblocking filter is decreased to 1 or 2 to perform deblocking. Currently, deblocking coefficients ranging up to 4 exist. If the deblocking coefficient is subdivided and the maximum value thereof is increased to 8 or 16, deblocking is performed using a low deblocking coefficient corresponding to the increased coefficient.

TABLE 1
Degree of Improvement of PSNR of Video Sequence

| | PSNR | | PSNR |
|---|---|---|---|
| Football_QCIF, | improvement | Football_QCIF, | improvement |
| 7.5 Hz | degree | 15 Hz | degree |
| 160 kbps | 0.1188 | 243 kbps | 0.0589 |
| 192 kbps | 0.1114 | 294 kbps | 0.0269 |
| 224 kbps | 0.0931 | 345 kbps | 0.0169 |
| 256 kbps | 0.0181 | 396 kbps | 0.0201 |
| 288 kbps | 0.0207 | 447 kbps | 0.0370 |
| 320 kbps | 0.0330 | 498 kbps | 0.0377 |
| | | 512 kbps | 0.0364 |

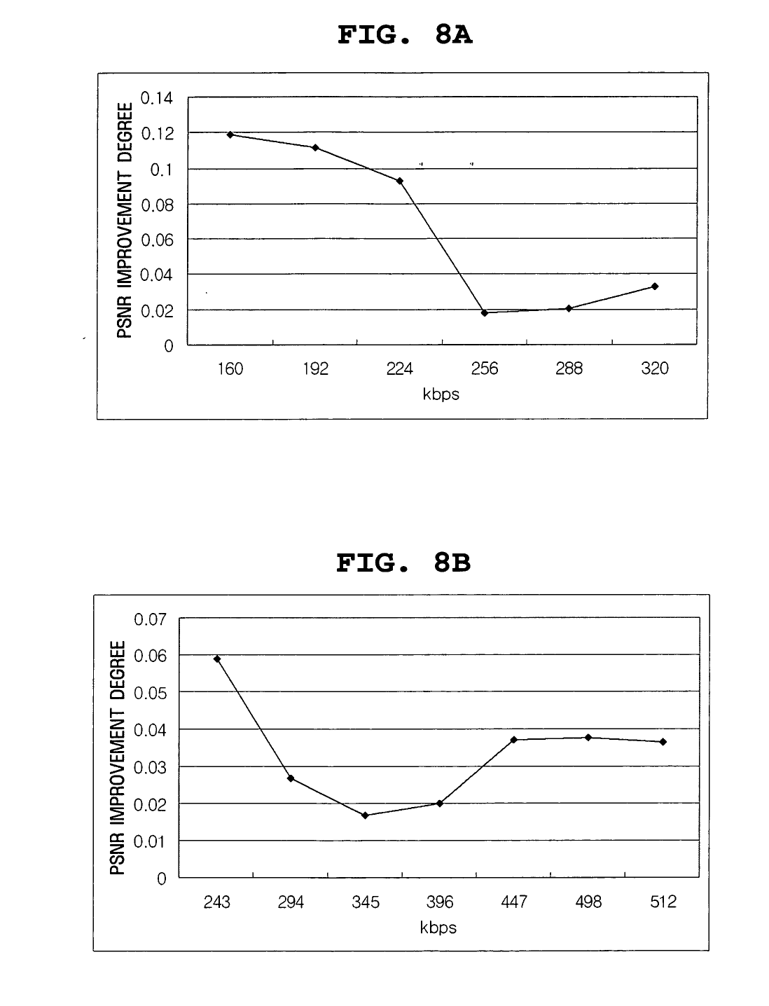

Table 1 shows results obtained according to an exemplary embodiment of the present invention. Here, a football moving picture is sampled at frequencies of 7.5 Hz and 15 Hz. Table 1 shows the degree of improvement of PSNR when the method of decreasing the deblocking coefficient, proposed in the present invention, is applied depending on the bit rate of a network. As shown in Table 1, it can be seen that the degree of improvement of the PSNR is high at a low rate (160 kbps and 192 kbps at 7.5 Hz, and 243 kbps at 15 Hz). The degree of improvement of Table 1 is displayed graphically in FIGS. 8A and 8B. FIG. 8A shows the degree of improvement of PSNR when video, sampled at a frequency of 7.5 Hz in the Quarter Common Intermediate Format (QCIF), is deblocked at a low intensity. FIG. 8B shows the degree of improvement of the PSNR when video, sampled at a frequency of 15 Hz in the QCIF, is deblocked at a low intensity. As shown in the two graphs, the degree of improvement of the PSNR is high when the bit rate is low.

TABLE 2
Degree of Improvement of PSNR of Video Sequence

| | PSNR | | PSNR |
|---|---|---|---|
| Football_CIF, | improvement | Football_CIF, | improvement |
| 15 Hz | degree | 30 Hz | degree |
| 588 kbps | 0.1146 | 920 kbps | 0.0758 |
| 690 kbps | 0.0946 | 1124 kbps | 0.0582 |
| 792 kbps | 0.0647 | 1328 kbps | 0.0302 |
| 894 kbps | 0.0515 | 1532 kbps | 0.0219 |
| 996 kbps | 0.0161 | 1736 kbps | 0.0085 |
| 1024 kbps | 0.0128 | 1940 kbps | 0.0204 |
| | | 2048 kbps | 0.0255 |

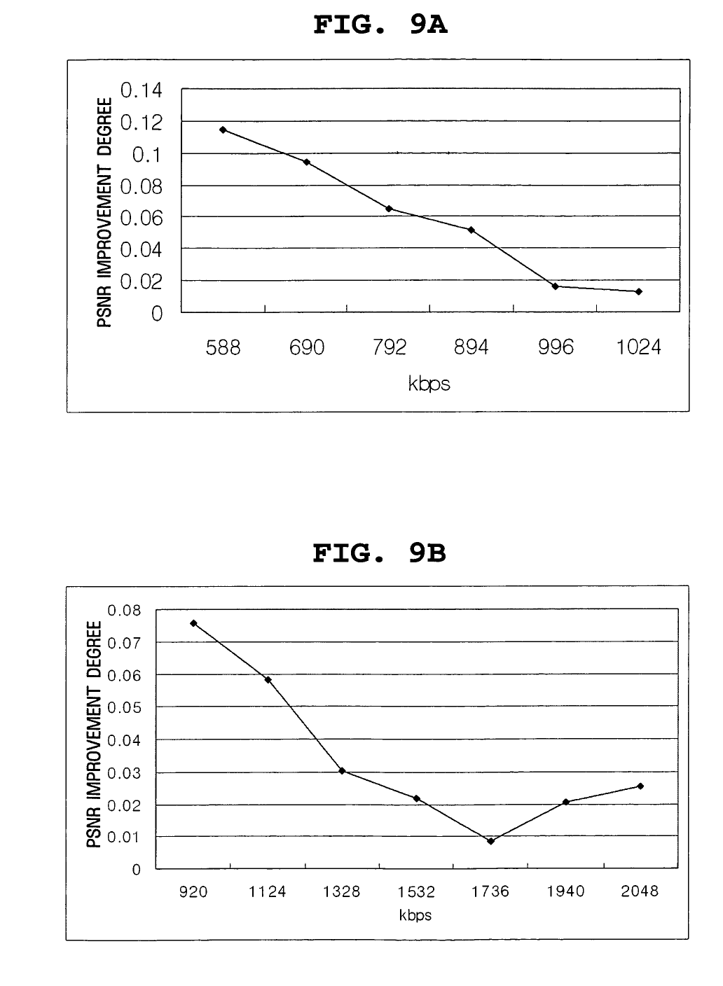

Table 2 shows results obtained according to an exemplary embodiment of the present invention. In the case where a football moving picture is sampled at a frequencies of 15 Hz and 30 Hz, Table 2 shows the degree of improvement of the PSNR when the method of decreasing a deblocking coefficient, proposed in the exemplary embodiment of the present invention, is applied depending on the bit rate of a network. As shown in Table 2, it can be seen that the degree of improvement of the PSNR is high at a low rate (588 kbps and 690 kbps at 15 Hz, and 920 kbps and 1124 Kbps at 30 Hz). The degree of improvement in Table 2 is displayed graphically in FIGS. 9A and 9B. FIG. 9A shows the degree of improvement of the PSNR when video, sampled at a frequency of 15 Hz in the QCIF, is deblocked at a low intensity. FIG. 9B shows the degree of improvement of the PSNR when video, sampled at a frequency of 30 Hz in the QCIF, is deblocked at a low intensity. As shown in the two graphs, the degree of improvement of the PSNR is high when the bit rate is low. That is, FGS is required when the bit rate of a network is low, so that the image quality is excellent if the degree of improvement of the PSNR is high while the bit rate is low, as shown in Tables 1 and 2 according to the method proposed in the present specification.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Therefore, it should be understood that the above embodiments are only exemplified in all aspects and are not restrictive. The scope of the present invention should be defined in the attached claims, rather than the detailed description. Those skilled in the art will appreciate that all modifications, equivalences and substitutions derived from the meaning and scope of the claims and concept equivalent thereto are included in the spirit and scope of the present invention defined by the attached claims.

Accordingly, the present invention is advantageous in that it can perform deblocking at a low intensity in video encoding and decoding that support FGS, thus improving a PSNR.

Further, the present invention is advantageous in that it can improve the quality of video while reducing data loss caused by deblocking.

What is claimed:

1. A Fine Granularity Scalability (FGS)-based video encoding method capable of controlling deblocking, comprising:
receiving original data of video and generating a base layer based on the original data;
obtaining the difference between the original data and data that is obtained by reconstructing the base layer and deblocking the reconstructed base layer, thus generating an enhancement layer;
generating a reconstructed frame, based on data that is obtained by reconstructing the enhancement layer, and the data that is obtained by deblocking the reconstructed base layer; and
deblocking the reconstructed frame at an intensity different from a deblocking intensity used in deblocking the reconstructed base layer.

2. The FGS-based video encoding method according to claim 1, wherein a deblocking intensity used in deblocking the reconstructed frame is lower than the deblocking intensity used in deblocking the reconstructed base layer.

3. The FGS-based video encoding method according to claim 1, wherein a deblocking coefficient used in deblocking the reconstructed frame is set to 1 or 2.

4. The FGS-based video encoding method according to claim 1, wherein generating of the base layer comprises transforming and quantizing the original data.

5. The FGS-based video encoding method according to claim 4, wherein the transformation comprises a Discrete Cosine Transform (DCT).

6. The FGS-based video encoding method according to claim 4, wherein reconstructing of the base layer comprises inverse transforming and inverse quantizing the original data which is transformed and quantized.

7. The FGS-based video encoding method according to claim 1, wherein generating of the enhancement layer comprises transforming and quantizing the difference between the original data and the data that is obtained by reconstructing the base layer and deblocking the reconstructed base layer.

8. The FGS-based video encoding method according to claim 1, wherein generating of the enhancement layer comprises generating two or more enhancement layers.

9. The FGS-based video encoding method according to claim 8, wherein generating of the enhancement layer comprises:
encoding residual data generated by the difference between the original data and the data that is obtained by reconstructing the base layer and deblocking the reconstructed base layer, thus generating a first enhancement layer; and
encoding a residual frame generated by the difference between a reconstructed frame and the original data, thus generating a second enhancement layer, the reconstructed frame being obtained by adding the data that is obtained by reconstructing the first enhancement layer to the data that is obtained by reconstructing the base layer and deblocking the reconstructed base layer.

10. The FGS-based video encoding method according to claim 1, wherein the original video data is data obtained by performing Motion-Compensated Temporal Filtering (MCTF) on a Group of Pictures (GOP).

11. A Fine Granularity Scalability (FGS)-based video decoding method capable of controlling deblocking, comprising:
receiving a video stream and extracting a base layer from the video stream;
extracting an enhancement layer from the video stream;
adding data that is obtained by reconstructing the base layer and deblocking the reconstructed base layer to data that is obtained by reconstructing the enhancement layer, thus generating a reconstructed frame; and
deblocking the reconstructed frame at an intensity different from a deblocking intensity used in deblocking the reconstructed base layer.

12. The FGS-based video decoding method according to claim 11, wherein the deblocking intensity used in the deblocking the reconstructed frame is lower than the deblocking intensity used in deblocking the reconstructed base layer.

13. The FGS-based video decoding method according to claim 11, wherein a deblocking coefficient used in deblocking the reconstructed frame is set to 1 or 2.

14. The FGS-based video decoding method according to claim 11, wherein reconstructing of the base layer comprises inverse transforming and inverse quantizing the base layer.

15. The FGS-based video decoding method according to claim 14, wherein the inverse transformation comprises an Inverse Discrete Cosine Transform (IDCT).

16. The FGS-based video decoding method according to claim 11, wherein reconstructing of the enhancement layer comprises inverse transforming and inverse quantizing the enhancement layer.

17. The FGS-based video decoding method according to claim 11, wherein extracting the enhancement layer comprises extracting two or more enhancement layers.

18. The FGS-based video decoding method according to claim 17, wherein extracting of the two or more enhancement layer comprises:
extracting a first enhancement layer from the video stream; and
extracting a second enhancement layer from remaining data of the video stream after extracting the first enhancement layer from the video stream.

19. A Fine Granularity Scalability (FGS)-based video encoder capable of controlling deblocking, the encoder comprising:
a base layer generation unit which generates a base layer based on original video data;
an enhancement layer generation unit which obtains a difference between the original data and data that is obtained by reconstructing the base layer and deblocking the reconstructed base layer, thus generating an enhancement layer;
a reconstructed frame generation unit which generates a reconstructed frame based on data that is obtained by reconstructing the enhancement layer, and the data that is obtained by deblocking the reconstructed base layer; and
a deblocking unit which deblocks the reconstructed frame at an intensity different from a deblocking intensity used in deblocking the reconstructed base layer.

20. The FGS-based video encoder according to claim 19, wherein the deblocking unit which deblocks the reconstructed frame is configured to have a deblocking intensity lower than the deblocking intensity used in deblocking the reconstructed base layer.

21. The FGS-based video encoder according to claim 19, wherein the deblocking unit which deblocks the reconstructed frame is configured to have a deblocking coefficient set to 1 or 2.

22. The FGS-based video encoder according to claim 19, wherein the base layer generation unit is configured to transform and quantize the original data.

23. The FGS-based video encoder according to claim 22, wherein transforming of the original data comprises a Discrete Cosine Transform (DCT).

24. The FGS-based video encoder according to claim 22, wherein one of the base layer generation unit and the enhancement layer generation unit is configured to inverse-transform and inverse-quantize the original data in reconstructing the base layer.

25. The FGS-based video encoder according to claim 19, wherein the enhancement layer generation unit is configured to transform and quantize the difference between the original data and the data that is obtained by reconstructing the base layer and deblocking the reconstructed base layer.

26. The FGS-based video encoder according to claim 19, wherein the enhancement layer generation unit is configured to generate two or more enhancement layers.

27. The FGS-based video encoder according to claim 26, wherein the enhancement layer generation unit comprises:
a first enhancement layer generation unit which encodes a residual data generated by the difference between the original data and the data that is obtained by reconstructing the base layer and deblocking the reconstructed base layer, thus generating a first enhancement layer; and
a second enhancement layer generation unit which encodes a residual frame generated by the difference between a reconstructed frame and the original data, thus generating a second enhancement layer, the reconstructed frame being obtained by adding the data that is obtained by reconstructing the first enhancement layer to the data that is obtained by reconstructing the base layer and deblocking the reconstructed base layer.

28. The FGS-based video encoder according to claim 19, wherein the original video data is data obtained by performing Motion-Compensated Temporal Filtering (MCTF) on a Group of Pictures (GOP).

29. A Fine Granularity Scalability (FGS)-based video decoder capable of controlling deblocking, the decoder comprising:
a base layer extraction unit which extracts a base layer from a received video stream;
an enhancement layer extraction unit which extracts an enhancement layer from the received video stream;
a reconstructed frame generation unit which adds data that is obtained by reconstructing the base layer and deblocking the reconstructed base layer to data that is obtained by reconstructing the enhancement layer, thus generating a reconstructed frame; and
a deblocking unit which deblocks the reconstructed frame at an intensity different from a deblocking intensity used in deblocking the reconstructed base layer.

30. The FGS-based video decoder according to claim 29, wherein the deblocking unit which deblocks the reconstructed frame is configured to have a deblocking intensity lower than the deblocking intensity used in deblocking the reconstructed base layer.

31. The FGS-based video decoder according to claim 29, wherein the deblocking unit which deblocks the reconstructed frame is configured to have a deblocking coefficient set to 1 or 2.

32. The FGS-based video decoder according to claim 29, the decoder further comprising:
an inverse quantization unit which inverse-quantizes the base layer; and
an inverse transform unit which inverse-transforms the inverse-quantized base layer,
wherein the data obtained by reconstructing the base layer and deblocking the reconstructed base layer is generated by deblocking the inverse-transformed base layer.

33. The FGS-based video decoder according to claim 32, wherein the inverse transformation comprises an Inverse Discrete Cosine Transform (IDCT).

34. The FGS-based video decoder according to claim 29, the decoder further comprising:
an inverse quantization unit which inverse-quantizes the enhancement layer; and
an inverse transform unit which inverse-transforms the inverse-quantized enhancement layer,
wherein the data obtained by reconstructing the enhancement layer is generated based on the inverse-transformed base layer.

35. The FGS-based video decoder according to claim 29, wherein the enhancement layer extraction unit is configured to extract two or more enhancement layers.

36. The FGS-based video decoder according to claim 35, wherein the enhancement layer extraction unit comprises:
a first enhancement layer extraction unit which extracts a first enhancement layer from the video stream; and
a second enhancement layer extraction unit which extracts a second enhancement layer from remaining data of the video stream after extracting the first enhancement layer from the video stream.
